(19) United States
(12) Patent Application Publication
(10) Pub. No.: US 2015/0097856 A1
(43) Pub. Date: Apr. 9, 2015

(54) IMAGE PROCESSOR AND NON-TRANSITORY COMPUTER READABLE MEDIUM

(71) Applicant: FUJI XEROX CO., LTD., Tokyo (JP)

(72) Inventor: Makoto SASAKI, Ashigarakami-gun (JP)

(73) Assignee: FUJI XEROX CO., LTD., Tokyo (JP)

(21) Appl. No.: 14/286,575

(22) Filed: May 23, 2014

(30) Foreign Application Priority Data
Oct. 4, 2013 (JP) 2013-209655

(51) Int. Cl. G09G 5/02

(52) U.S. Cl. CPC G09G 5/02; G09G 2320/0666; G09G 2320/0242
USPC 345/600

(57) ABSTRACT

An image processor including: a color converting unit converting an original image to a brightness image and a chromaticity image; an illumination image generating unit generating, from the brightness image, an illumination image; an image generation processing unit executing a processing for generating a brightness reproduction image which is reproduced so that visibility of the original image is enhanced, based on the brightness image, the illumination image, and an enhancing degree information which represents an enhancing degree of a reflection rate component of the original image, a chromaticity adjustment image generating unit generating a chromaticity adjustment image by adjusting chromaticity of the chromaticity image, and a color reverse converting unit performing a conversion reverse to a color conversion performed by the color converting unit, with respect to the brightness reproduction image and the chromaticity adjustment image.

### CROSS REFERENCE TO RELATED APPLICATIONS

This application is based on and claims priority under 35 USC §119 from Japanese Patent Application No. 2013-209655 filed October 4.

### BACKGROUND

1. Technical Field

The present invention relates to an image processor and a non-transitory computer readable medium.

2. Related Art

Recently, various image processing techniques have been known in which a processing is performed on an image by using color.

### SUMMARY

According to an aspect of the present invention, there is provided an image processor including a color converting unit that converts an original image to a brightness image in which a brightness component of the original image is set to be a pixel value and a chromaticity image in which a chromaticity component of the original image is set to be a pixel value; an illumination image generating unit that generates, from the brightness image, an illumination image in which an illumination component of the original image is set to be a pixel value; an image generation processing unit that executes a processing for generating a brightness reproduction image which is reproduced so that visibility of the original image is enhanced, based on the brightness image, the illumination image, and an enhancing degree information which represents an enhancing degree of a reflection rate component of the original image, a chromaticity adjustment image generating unit that generates a chromaticity adjustment image by adjusting chromaticity of the chromaticity image, and a color reverse converting unit that performs a conversion reverse to a color conversion performed by the color converting unit, with respect to the brightness reproduction image and the chromaticity adjustment image.

### BRIEF DESCRIPTION OF THE DRAWINGS

An exemplary embodiment of the present invention will be described in detail based on the following figures, wherein:

FIG. 1 is a block diagram showing a functional configuration of an image processor in the first exemplary embodiment of the present invention;

FIGS. 2A to 2C are diagrams showing that a frequency of an image in each layer of the multi-layer in accordance with a value σ;

FIG. 3 is a diagram showing a first specific example of presumption of illumination light by an illumination presuming portion;

FIG. 4 is a diagram showing a second specific example of presumption of illumination light by an illumination presuming portion;

FIG. 5 is a diagram showing a specific example of a function used for conversion of saturation by a chromaticity reproducing portion;

FIGS. 6A and 6B are diagrams showing a specific example of functions used in substance of conversion of hue by a chromaticity reproducing portion and for the conversion;

FIG. 7 is a diagram showing a specific example of chromaticity coordinates of chromaticity space in which conversion of chromaticity is performed by the color reproducing portion;

FIG. 8 is a diagram showing a specific example of the conversion of chromaticity by chromaticity reproducing portion;

FIG. 9 is a flowchart showing an operation example of the image processor in the first exemplary embodiment of the present invention;

FIG. 10 is a block diagram showing a functional configuration of an image processor in the second exemplary embodiment of the present invention;

FIGS. 11A and 11B are diagrams showing a specific example of an image used in the second exemplary embodiment and the third exemplary invention and a specific example of a particular region image corresponding to the specific example of the image;

FIG. 12 is a diagram showing a specific example of a function determined by a brightness reproduction parameter used by a brightness reproducing portion or a synthesis reflection rate presuming portion;

FIG. 13 is a flowchart showing an operation example of the image processor in the second exemplary embodiment of the present invention;

FIG. 14 is a block diagram showing a functional configuration of an image processor in the third exemplary embodiment of the present invention;

FIG. 15 is a flowchart showing an operation example of the image processor in the third exemplary embodiment of the present invention; and

FIG. 16 is a block diagram showing a hardware configuration example of the image processor in the present exemplary embodiment of the present invention.

### DETAILED DESCRIPTION

Hereinafter, an exemplary embodiment of the present invention will be described in detail with reference to the attached drawings.

### Background of Invention

We generally use a PC (personal computer) while looking at a monitor to perform an operation of making a document with images. In such a operation, users who use Information and Communication Technology (ICT) devices such as tablet computers and the like having been popular in these days are increased.

In general, change of environmental light scarcely has an effect on the users in an office environment like a place for clerical work or a Desk Top Publishing (DTP) work. On the other hand, while the ICT devices that are comfortably portable have a merit of enabling users to work anywhere, the but ICT devices also have the demerit of being affected by circumstances where the devices are carried, such as change of environmental light.

Further, in an operation of using images, other than the above-described operation of making a document, an operation of storing images which are took by users with a camera-equipped tablet and the like in each device is performed. Such a scene where users share images each other and explain a situation with images have become common.

As described above, “easily usable” and “usable in various places” are provided as a feature of the recent monitor environment, which is different from the conventional monitor environment. In the recent monitor environment, “visibility” is more focused than color adjusting since the using method and the usage environment are different from those in conventional monitor environment.

“Visibility” represents a feature of whether a visual object is clearly seen or not. Basic methods of a field of image processing represented by Gamma correction, histogram equalization, dynamic range compression and the like are provided as a method for improving visibility of an image.

In gamma correction, a curve which heaps up dark sections and an objective region is generated and is applied to pixel values, thereby, the dark sections get brighter. In histogram equalization, a curve which removes a bias of a histogram of an image is generated and is applied to pixel values, thereby; a reproduction of smoothing the histogram is performed. In dynamic range compression, a low brightness and a high brightness are represented without lowering a contrast by changing a correction amount in accordance with an ambient luminance of the image.

There is a method employing Retinex principle among methods for improving visibility utilizing a visual feature. Retinex principle is a basic principle for improving visibility by enhancing the reflection rate components based on the idea that a human perceives scenes by a reflection rate.

Furthermore, improvement of color reproducibility and the like at the time of displaying or drawing the image is also required along with performance advances of cameras equipped with the ICT devices. As a representative example of such a color reproducibility, “memory color reproduction” is provided. A memory color is a color that is reminded associated with a word represented such as skin color, sky blue and the like. It is also found that a memory color is more preferred when being enhanced than an actual color. Further, in the field of image correcting, it is usually preferable to execute an image processing of correcting brightness, color saturation and the like.

However, in general, it is not easy to balance both of visibility improvement and color reproducibility in a scene of image.

Therefore, in the present embodiment, both of visibility and color reproducibility in a scene are improved by configuring a model based on visibility feature. Especially, an image processing which enables to gain both of visibility improvement and memory color reproduction is executed.

### First Exemplary Embodiment

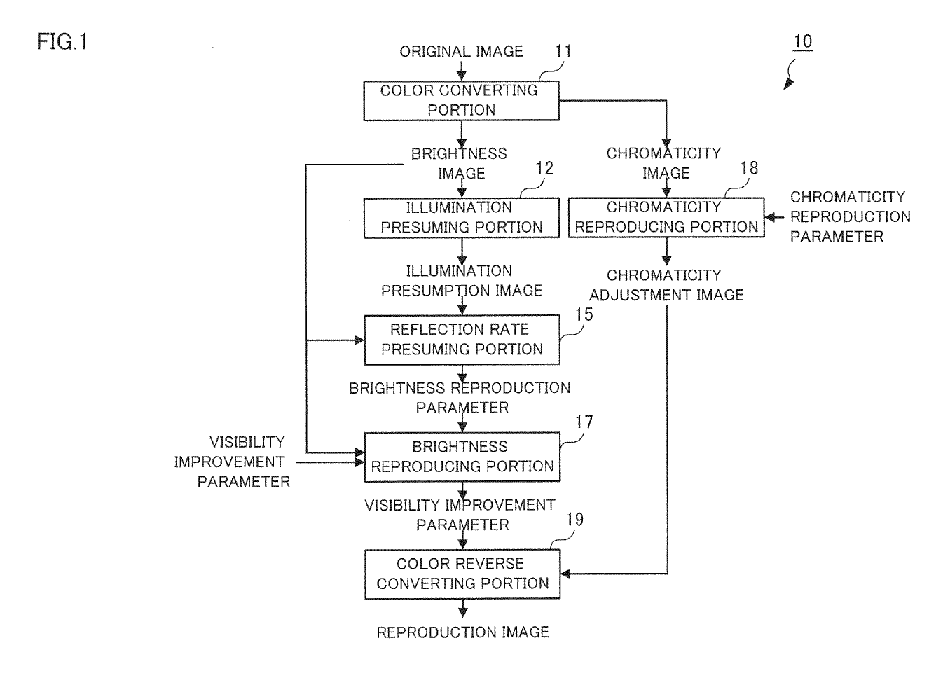

FIG. 1 is a block diagram showing a functional configuration of an image processor 10 in the first exemplary embodiment of the present invention. As shown in the figure, the image processor 10 in the first exemplary embodiment includes; a color converting portion 11, an illumination presuming portion 12, a reflection rate presuming portion 15, a brightness reproducing portion 17, a chromaticity reproducing portion 18, and a color reverse converting portion 19.

The color converting portion 11 converts an original image to brightness and chromaticity. Since RGB image as represented by sRGB and the like is generally used as the original image, a conversion RGB to YCbCr, a conversion RGB to L*a*b*, a conversion RGB to HSV and the like are provided as the color conversion. These conversions are performed by employing a predetermined conversion formula. In the present exemplary embodiment, explanation will be given assuming that the color space after the conversion is HSV. In the case where the color space is HSV, a brightness image is one plane of a V image, and a chromaticity image is two planes of a HS image.

In the present exemplary embodiment, the color converting portion 11 is provided as an example of a color converting unit that executes a color conversion to convert an original image to a brightness image and a chromaticity image.

The illumination presuming portion 12 presumes illumination components of a scene represented by the original image based on the brightness image (in the present exemplary embodiment, the V image) generated by the color conversion portion 11 (hereinafter, an image of the presumed illumination components is referred to as “an illumination presumption image”). In the present exemplary embodiment, two specific examples are provided as the presumption of illumination components.

In first example of presumption of illumination components, Gaussian function is used. The visibility of humans has a feature of presuming the illumination light by periphery of an attention region. Retinex principle is a model based on this idea, thus a smoothing processing is performed on an image. In the present exemplary embodiment, the smoothing processing is performed by employing Gaussian function as below.

$$G ( x , y ) = k exp ( - \frac{{x}^{2} + {y}^{2}}{{σ}^{2}} ) \qquad ( Formula 1 )$$

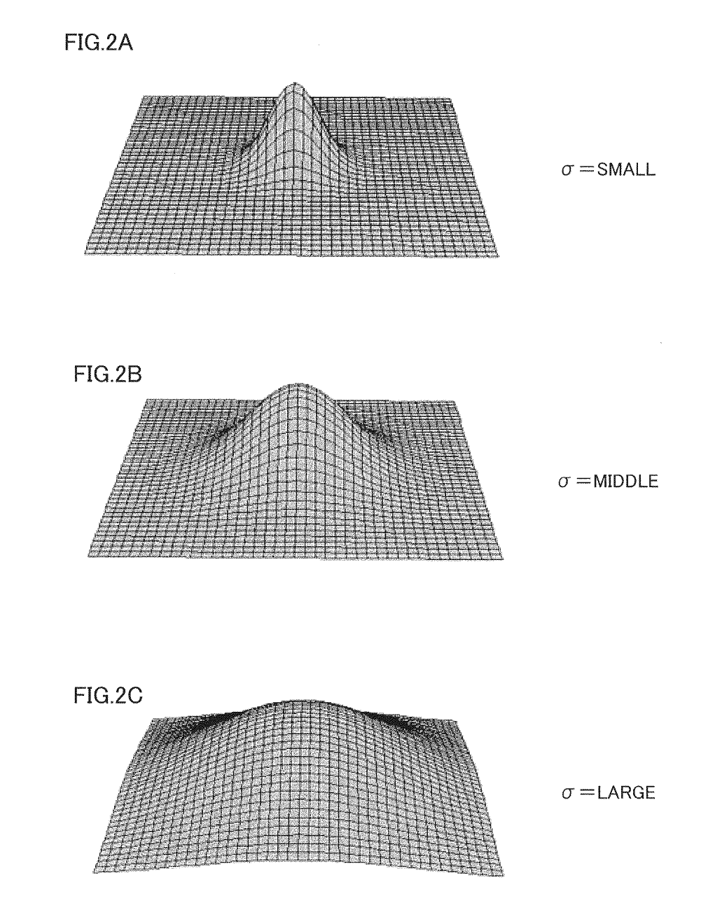

Here, x and y represent a pixel position, k represents a coefficient which is for normalizing the result of the integration with respect to the pixel amount of a filter size of the image processing into 1, and σ represents a ratio of smoothness (scale). Note that, the above function is an example, and any filters may be used as long as an image is smoothed as a result. For example, a bilateral filter known as a smoothing filter for edge-storing, which is a filter of a function transformed from Formula 1, may be used. Also, Moving-average method may be used. Any methods may be used as long as the essence of smoothness is not lost. The change of an image when σ of Formula 1 is changed is shown in FIGS. 2A to 2C. Specifically, the frequency becomes high when σ is small as shown in FIG. 2A, the frequency becomes low when σ is large as shown in FIG. 2C, and the frequency becomes about middle degree when σ is middle degree as shown in FIG. 2B.

As to the smoothness, only a layer of one scale may be used, however, using multi-layer (multi-scale) in which scales are varied improves robustness in the presumption of illumination components.

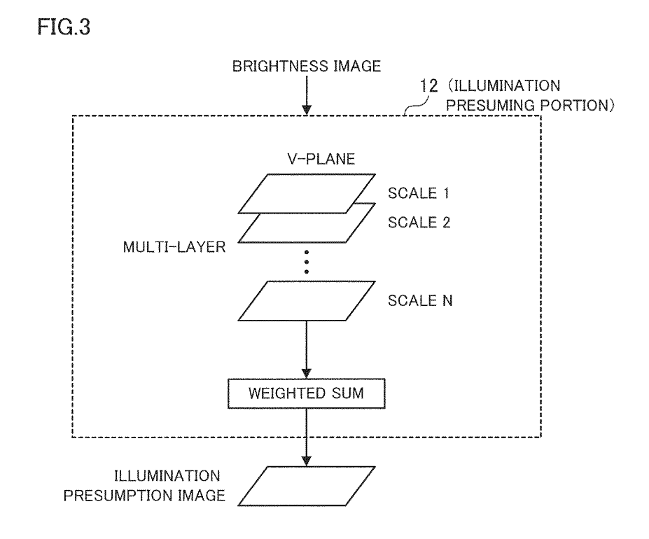

FIG. 3 shows a state of generating the illumination presumption image by the illumination presuming portion 12 in this specific example. For example, it is preferable to give the weighted sum of the image configured with N layers which includes each of a scale 1 to a scale N, to presume the illumination light as below.

$$L ( x , y ) = {\sum }_{n = 1}^{N} {W}_{n} {G}_{n} ( x , y ) ⊗ I ( x , y ) \qquad ( Formula 2 )$$

Here, L(x, y) represents a pixel value of the illumination presumption image, Gₙ(x, y) represents Formula 1 applied to the scale n, I(x, y) represents a pixel value of the original image, Wₙ represents a bias of the scale n, and “x” circled by “o” represents convolution. Note that, Wₙ may be simply given 1/N, or Wₙ may be variable in accordance with layers as well. In the case where the illumination presumption is performed as in FIG. 3, since the Formula 2 is applied to the V-plane, the Formula 2 is apprehended as below.

$${L}_{V} ( x , y ) = {\sum }_{n = 1}^{N} {W}_{n} {G}_{n} ( x , y ) ⊗ {I}_{V} ( x , y ) \qquad ( Formula 3 )$$

Here, Lv(x,y) represents a pixel value of the illumination presumption image acquired from the brightness image, and Iv(x,y) represents a pixel value of the brightness image.

Note that, at least a layer of one scale is required for the presumption of illumination components. At least the layer of the one scale may be the one selected from layers of generated plural scales.

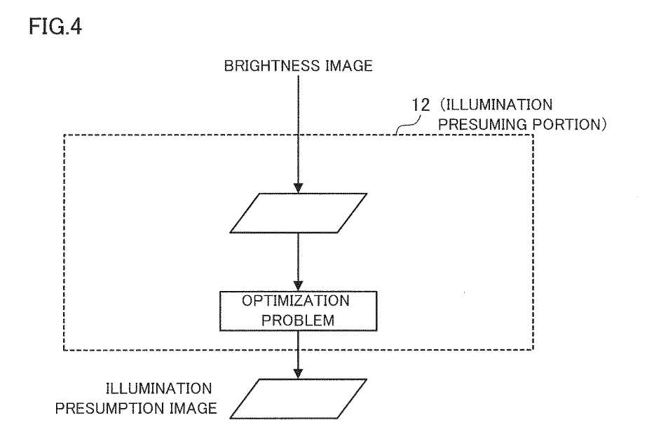

Further, the second example of the presumption of illumination components is a method of optimizing the brightness image itself as in FIG. 4. Such a presumption of the illumination components may be performed by utilizing the techniques disclosed in a document “R. Kimmel, M. Elad, D. Shaked, R. Keshet, and I. Sobel, “A variational framework for retinex,” Int. J. Comput. Vis., vol. 52, no. 1, pp 7-23, January 2003”. That is, the method disclosed in the above document that, the illumination component L itself is set at unknown, an energy function that represents spatial smoothness of L is defined by using a pixel value I (known) of the original image, and the solution is calculated by taking the energy function as Second-order programming problem of L, may be used to figure out L. For example, on the assumption that the illumination light is smooth in space, the energy function of L in which the smoothness is regarded as E is defined as below.

E(L)=∫∫(|log L(x,y)|²+a(log L(x,y)−log I(x,y))²+b|∇(log L(x,y)−log I(x,y))²|)dxdy

Here, a and b are parameters for controlling smoothness. It is possible to analytically solve as a Second-order programming problem because E(L) is a second-order expression of log L(x, y). Otherwise, any other analytical methods publicly known may be applied.

In the present exemplary embodiment, the illumination presumption image is used as an example of an illumination image in which the illumination component of the original image is set to be a pixel value, and the illumination presuming portion 12 is provided as an example of an illumination image generating unit that generates the illumination image.

The reflection rate presumption portion 15 presumes the reflection rate of the original image by calculating a proportion of the pixel values of the original image to the pixel values of the illumination presumption image. Specifically, the image represents the reflection rate (hereinafter, refer to as “a reflection rate presumption image”) is figured out as below.

$$R ( x , y ) = \frac{I ( x , y )}{L ( x , y )} \qquad ( Formula 4 )$$

Here, R(x, y) represents a pixel value of the reflection rate presumption image, I(x, y) represents a pixel value of the brightness image, and L(x, y) represents a pixel value of the illumination presumption image. Note that, in the present exemplary embodiment, since the brightness image is given as V-image of HSV, Formula 4 is interpreted like Formula 3.

In the present exemplary embodiment, the reflection rate presumption image is used as an example of a reflection rate image in which the reflection rate component of the original image based on the brightness image and the illumination image is set to be the pixel value, and the reflection rate presumption portion 15 is provided as an example of a reflection rate image generating unit that generates the reflection rate image based on the brightness image and the illumination image. The image reproducing portion 17 executes a processing of enhancing the reflection rate components based on the original image and the reflection rate presumption image generated by the reflection rate presumption portion 15. For example, the brightness reproduction image is generated by the reproduction formula as below.

[symbol]

(x,y)=αR(x,y)+(1−α)I(x,y) (Formula 5)

Here, Î(x, y) represents a pixel value of the brightness reduction image. Moreover, α is a parameter representing the degree of visibility improvement and corresponds to the visibility improvement parameter (reflection rate enhancing degree information) in FIG. 1. Î(x, y) is the reflection rate itself in the case of α=1, and Î(x, y) is a pixel value of the brightness image in the case of α=0. In the exemplary embodiment, a may be any value of from 0 to 1. Note that, a hat sign is attached at the top of a symbol in a formula, however, in this specification, attached at the right side of a symbol.

Moreover, the reduction formula is not limited to Formula 5, and the reproduction formula may be as shown below.

[symbol]

(x,y)=α log(R(x,y))+const (Formula 6)

Here, α is a parameter representing a gain of the reflection rate, and corresponds to the visibility improvement parameter (reflection rate enhancing degree information) in FIG. 1. While log represents a visibility feature in a study field, log functions as gain in the image processing. Further, const is a constant representing an intercept of the reproduction formula. FIG. 1 shows the case where the brightness reproducing portion 17 generates the brightness reproduction image by using the brightness image, however, in the case of using Formula 6, the brightness reproducing portion 17 generates the brightness reproduction image without using the brightness image.

Note that, in the present exemplary embodiment, it is described that the brightness reproducing portion 17 reproduces an image by using Formula 5 or Formula 6, however, the image may be reproduced by using any formula as long as the essence of the present invention is not lost.

In the present exemplary embodiment, the brightness reproducing portion 17 is provided as an example of a brightness reproduction image generating unit that generates the brightness reproduction image based on at least the reflection rate image and the reflection rate enhancing degree information.

In the present exemplary embodiment, the processing portion configured with the reflection rate presumption portion 15 and the brightness reproducing portion 17 is an example of image generation processing unit that executes a processing for generating the brightness reproduction image reproduced so that visibility of the original image is improved.

The chromaticity reproducing portion 18 performs a control of the chromaticity image (in the present exemplary embodiment, H and S) generated by the color converting portion 11. Note that, CbCr corresponds to the chromaticity image in YCbCr color space, and a*b* corresponds to the chromaticity image in L*a*b* color space. Specifically, the saturation contrast is enhanced and texture of color is improved by converting saturation S, for example, as below.

Ŝ(x,y)=fₛ(S) (Formula 7)

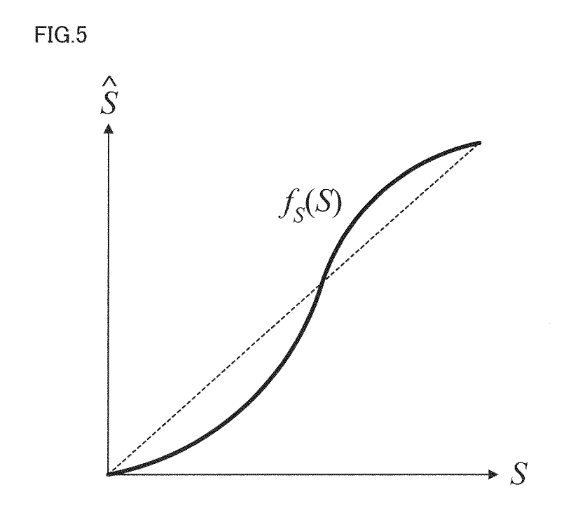

Herein, the shape like in FIG. 5A may be adapted as contrast function f_{S}, for example. Note that, a parameter which controls the shape of the function f_{S} corresponds to the chromaticity reproduction parameter in FIG. 1.

In the case where changing hue is important such as skin color, sky blue and the like, hue H may be converted, for example, as below.

Ĥ(x,y)=f_{H}(H) (Formula 8)

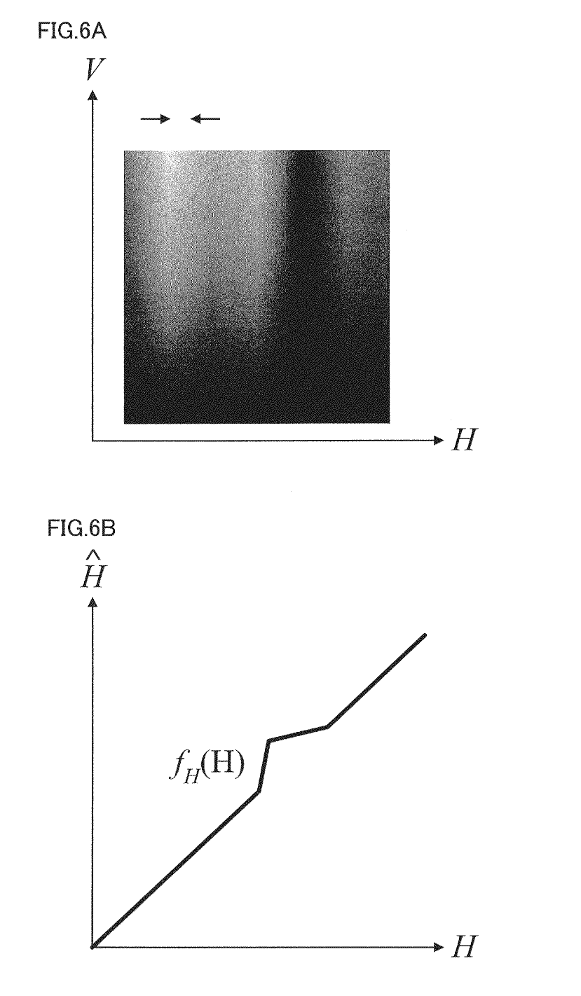

Herein, a function that converts hue as shown in FIG. 6A may be adapted as the function f_{H}. In FIG. 6A, with a right-pointing arrow and a left-pointing arrow, a conversion in which a hue surrounding one hue is converted to be nearer the surrounded hue is shown. In this case, the function f_{H} may have the shape in FIG. 6B, for example. Note that, a parameter controlling the shape of this function f_{H} also corresponds to the chromaticity reproduction parameter in FIG. 1.

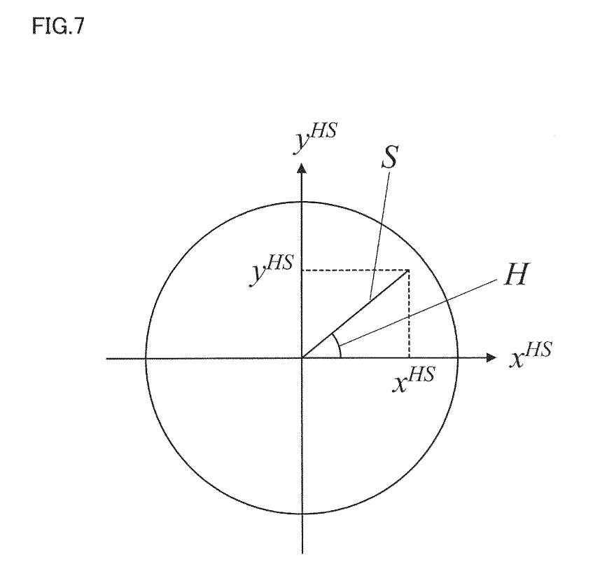

Otherwise, color adjustment may be performed in chromaticity space by converting H and S to the chromaticity coordinates like in FIG. 7. A conversion of H and S to x^{HS} and y^{HS} in FIG. 7 is performed by the below-described formula.

$${x}^{HS} = S cos ( \frac{H}{180} ) π \\ {y}^{HS} = S sin ( \frac{H}{180} ) π \qquad ( Formula 9 )$$

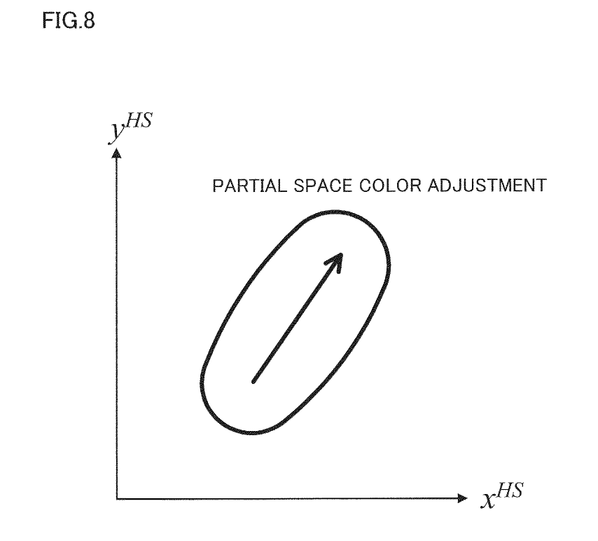

In the chromaticity coordinates after the conversion by employing formula 9, a partial space is configured and a color adjustment (a partial space color adjustment) is performed inside the partial space like in FIG. 8, thereby, the chromaticity adjustment, in which it causes no effect on except the predetermined range of ambient of a particular color, is performed. Such a conversion may be performed, for example, by using the method disclosed in Japanese Patent Application Laid-open Publication No. 2004-112694. Note that, a parameter which controls the partial space color adjustment also corresponds to the chromaticity reproduction parameter in FIG. 1.

In the present exemplary embodiment, the chromaticity reproducing portion 18 is provided as an example of a chromaticity adjustment image generating unit that generates a chromaticity adjustment image.

The color reverse converting portion 19 performs a color conversion reverse to the color conversion performed by the color conversion portion 11 when the brightness reproduction image improving visibility and the chromaticity image securing reproducibility of chromaticity are generated as described above. That is, the reproduction image, which is acquired by the series of processing in the first exemplary embodiment, is regarded as ĤŜV̂, and the ĤŜV̂ color space is converted to RGB color space, thereby; the final reproduction image is acquired.

In the present exemplary embodiment, the color reverse converting portion 19 is provided as an example of a color reverse converting unit that performs a conversion reverse to the color conversion performed by the color conversion unit.

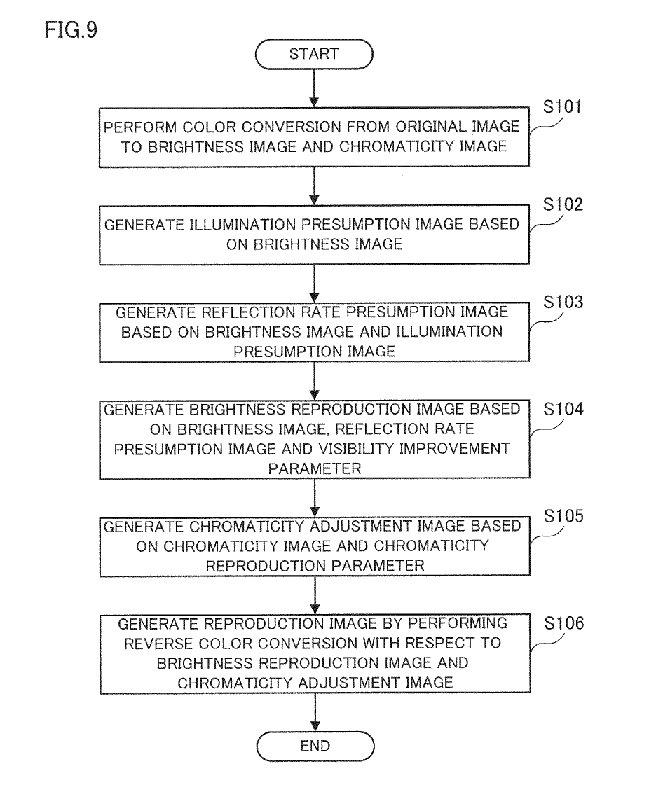

FIG. 9 is a flowchart showing an operation example of the image processor 10 in the first exemplary embodiment of the present invention.

When the original image is inputted, firstly, the color converting portion 11 generates the brightness image and the chromaticity image by performing, on the original image, the color conversion from the color space of the original image to color space of brightness and chromaticity (step 101).

Next, the illumination presuming portion 12 generates the illumination presumption image based on the brightness image generated in step 101 as shown in FIG. 3 and FIG. 4 (step 102). Subsequently, the reflection rate presuming portion 15 generates the reflection rate presumption image based on the brightness image generated in step 101 and the illumination presumption image generated in step 102 (step 103). Thereafter, the brightness reproducing portion 17 generates the brightness reproduction image based on the brightness image generated in step 101, the reflection rate presumption image generated in step 103, and the visibility improvement parameter (step 104). Note that, herein, it is described that the brightness image is used on the assumption that the brightness reproduction image is generated by using Formula 5, however, in the case where the brightness reproduction image is generated by using Formula 6, the brightness image may not be used in step 104. Further, the chromaticity reproducing portion 18 generates the chromaticity adjustment image based on the chromaticity image generated in step 101 and the chromaticity reproduction parameter (step 105). Here, step 102 to step 105 are performed in this order, however, those steps may be performed in any orders as long as step 103 is performed after step 102 and thereafter step 104 is performed. Otherwise, at least one steps of step 102 to step 104, and step 105 may be performed in parallel.

Lastly, the color reverse converting portion 19 generates the reproduction image by performing a color conversion reverse to the color conversion performed by the color conversion portion 11, that is, by performing a color conversion of the color space of brightness and chromaticity to the color space of the original image, with respect to the brightness reproduction image generated in step 104 and the chromaticity adjustment image generated in step 105 (step 106).

### Second Exemplary Embodiment

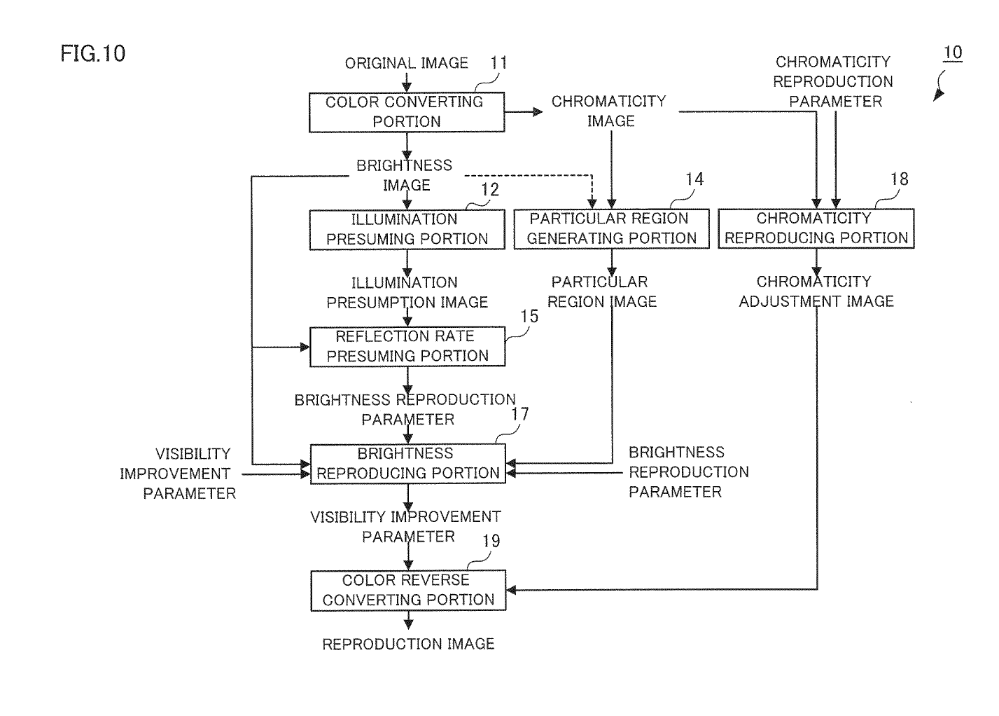

FIG. 10 is a block diagram showing a functional configuration of an image processor 10 in the second exemplary embodiment of the present invention. As shown in the figure, the image processor 10 in the second exemplary embodiment includes; a color converting portion 11, an illumination presuming portion 12, a particular region generating portion 14, a reflection rate presuming portion 15, a brightness reproducing portion 17, a chromaticity reproducing portion 18, and a color reverse converting portion 19. In other words, in the second exemplary embodiment, the image processor 10 includes, in addition to the configurations in the first exemplary embodiment; the particular region generating portion 14 which generates a particular region having color which is inside an attention color region. The chromaticity reproducing portion 18 performs a control of a chromaticity image in the attention color region, and in the second exemplary embodiment, an ingenuity is exercised to a conversion of brightness in an attention region in accordance with the attention color region. Here, the color converting portion 11, the illumination presuming portion 12, the reflection rate presuming portion 15, the chromaticity producing portion 18, and the color reverse converting portion 19 are the same configurations as those in the first exemplary embodiment, thereby, explanations thereof are omitted. Hereinbelow, the particular region generating portion 14 and the brightness reproducing portion 17 will be explained.

The particular region generating portion 14 generates, mainly from a chromaticity image, an image (hereinafter, referred to as “a particular region image”) which represents the particular region having the color inside the attention color region. However, since the particular region generating portion 14 refers to the brightness image in generating the particular region image in some cases, a dotted arrow is drawn from the brightness image to the particular region generating portion 14 in FIG. 10. The particular region image is equivalent to a mask image which represents the region degree which is a value from 0 to 1. As the attention color region has a representative-color, for example, the representative-color may be given on the chromaticity coordinates such as the above-described x^{HS}, y^{HS}, CbCr, a*b* and the like. In the case of considering brightness, the representative-color may be given in any color space as long as the representative-color can be given such as HSV, YCbCr, L*a*b* and the like.

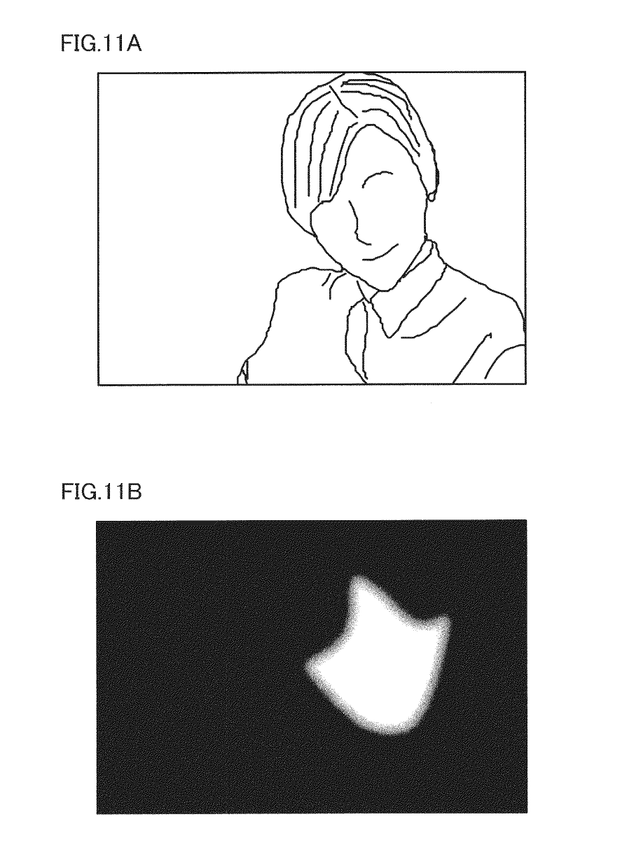

After giving the representative-color in such a manner, the particular region generating portion 14 calculates distances from the representative-color to the pixel values of all the pixels of the chromaticity image or the original image, thereby, generates the particular region image in which a distance to the pixel is respectively set as a weight representing a degree of the particular region. For example, by applying a part of the method disclosed in Japanese Patent Application Laid-Open Publication No. 2003-248824 or in Japanese Patent Application Laid-Open Publication No. 2006-155595, the particular region image is generated. Such a generation of the particular region image is shown in FIG. 11A and FIG. 11B. In other words, in the case where the image is the one shown in FIG. 11A, the particular region image shown in FIG. 11B is generated.

In the present exemplary embodiment, the particular region image is used as an example of a region image that represents a color region inside the designated color region in the original image, and the particular region generating portion 14 is provided as an example of a region image generating unit that generates the region image.

The brightness reproducing portion 17 changes, as shown below, reproducibility of the particular region in accordance with the pixel value of the particular region image generated as above-described.

[symbol]

(x,y)=αR(x,y)+(1−w(x,y))(1−α)I(x,y)+w(x,y)f(I(x,y)) (Formula 10)

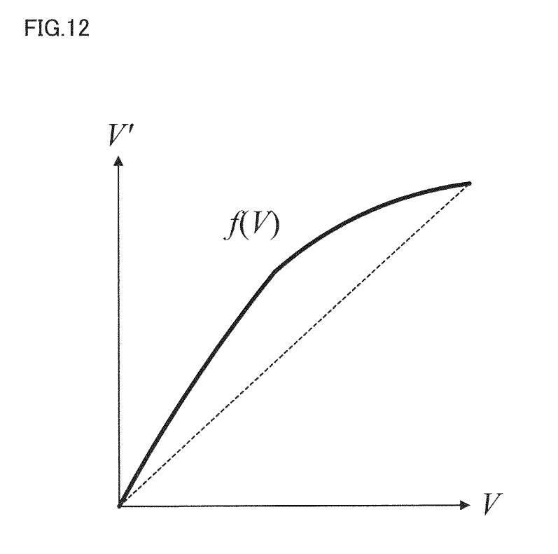

Herein, f is a function for converting brightness. For example, function f may have the shape shown in FIG. 12, and a parameter which controls the shape corresponds to the brightness reproduction parameter in FIG. 10. Moreover, w(x,y) represents a pixel value of the particular region image. Further, α is a parameter which represents a degree of visibility improvement, and corresponds to visibility improvement parameter (reflection rate enhancing degree information) in FIG. 10. By performing such a conversion, visibility of a scene is improved and brightness enhancement different from the other regions is performed is the particular region.

In the present exemplary embodiment, the brightness reproducing portion 17 is provided as an example of the brightness reproduction image generating unit that generates a brightness reproduction image based on a brightness image, a reflection rate image, reflection rate enhancing degree information, a region image, and brightness enhancing degree information.

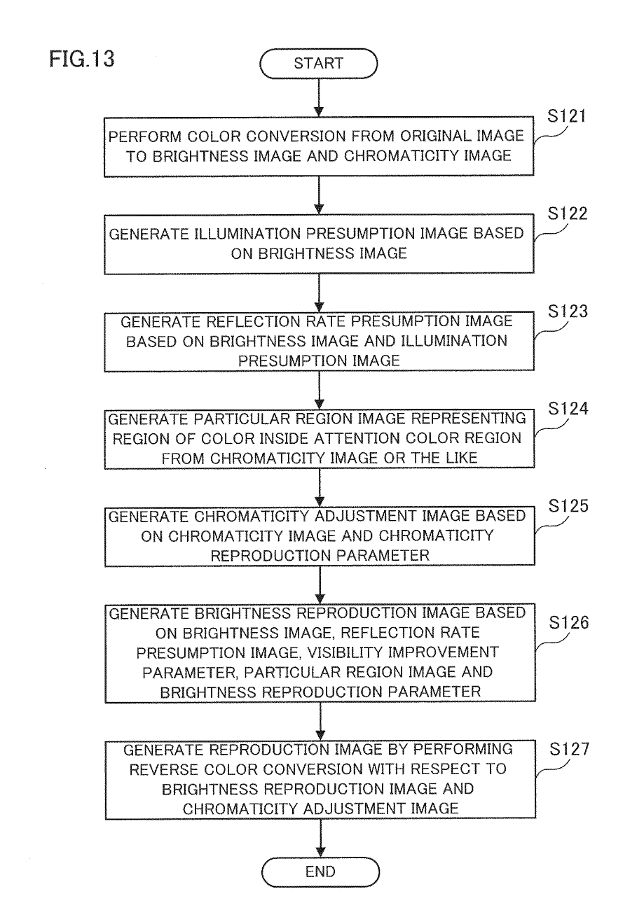

FIG. 13 is a flowchart showing an operation example of the image processor in the second exemplary embodiment of the present invention.

When the original image is inputted, firstly, the color converting portion 11 generates the brightness image and the chromaticity image by performing, on the original image, the color conversion from the color space of the original image to color space of brightness and chromaticity (step 121).

Next, the illumination presuming portion 12 generates the illumination presumption image based on the brightness image generated in step 121 as shown in FIG. 3 and FIG. 4 (step 122). Subsequently, the reflection rate presuming portion 15 generates the reflection rate presumption image based on the brightness image generated in step 121 and the illumination presumption image generated in step 122 (step 123). Moreover, the particular region generating portion 14 generates the particular region image which represents the particular region having the color inside the attention color region from the chromaticity image or the like generated in step 121 (step 124). Further, the chromaticity reproducing portion 18 generates the chromaticity adjustment image based on the chromaticity image generated in step 121 and the chromaticity reproduction parameter (step 125). Here, step 122 to step 125 are performed in this order, however, those steps may be performed in any orders as long as step 123 is performed after step 122. Otherwise, at least one steps of step 122 and step 123, step 124 and step 125 may be performed in parallel.

Subsequently, the brightness reproducing portion 17 generates the brightness reproduction image based on the brightness image generated in step 121, the reflection rate presumption image generated in step 123, the visibility improvement parameter, the particular region image generated in step 124, and the brightness reproduction parameter (step 126).

Lastly, the color reverse converting portion 19 generates the reproduction image by performing a color conversion reverse to the color conversion performed by the color converting portion 11, that is, by performing a color conversion from the color space of brightness and chromaticity to the color space of the original image, with respect to the brightness reproduction image generated in step 126 and the chromaticity adjustment image generated in step 125 (step 127).

### Third Exemplary Embodiment

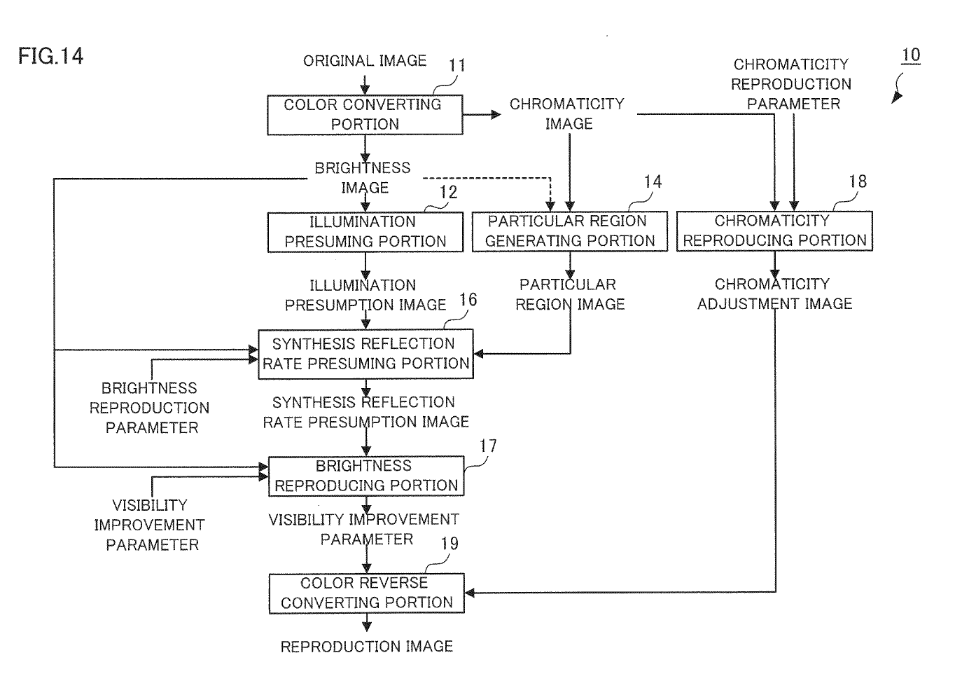

FIG. 14 is a block diagram showing a functional configuration of an image processor 10 in the third exemplary embodiment of the present invention. As shown in the figure, the image processor 10 in the third exemplary embodiment includes; a color converting portion 11, an illumination presuming portion 12, a particular region generating portion 14, a synthesis reflection rate presuming portion 16, a brightness reproducing portion 17, a chromaticity reproducing portion 18, and a color reverse converting portion 19. In the third exemplary embodiment, the method of calculating the reflection rate is different from those in the first exemplary embodiment and in the second exemplary embodiment. A similar image to that in the first exemplary embodiment or in the second exemplary embodiment is acquired as the reproduction image, however, the conversion as in the third exemplary embodiment may be performed. By performing such a conversion, the enhancement of the particular region is performed at the stage of the reflection rate calculation, then only the visibility improvement parameter is controlled by the brightness reproducing portion 17. Herein, the color converting portion 11, the illumination presuming portion 12, the particular region generating portion 14, the brightness reproducing portion 17, the chromaticity producing portion 18, and the color reverse converting portion 19 are the same configuration as those in the first exemplary embodiment, thereby, explanations thereof are omitted. Hereinbelow, the synthesis reflection rate presuming portion 16 will be explained.

The synthesis reflection rate presuming portion 16 presumes a reflection rate of the original image while synthesizing the illumination presumption image with the particular region image. Specifically, the image (hereinafter, referred to as “a synthesis reflection rate presumption image”) which is synthesized with the particular region image and represents the reflection rate is figured out as below.

$$R ( x , y ) = \frac{w ( x , y ) I ( x , y ) + ( 1 - w ( x , y ) ) f ( I ( x , y ) )}{L ( x , y )} \qquad ( Formula 11 )$$

Herein, f is a function for converting brightness. For example, function f may have the above-described shape shown in FIG. 12, and a parameter which controls the shape corresponds to the brightness reproduction parameter in FIG. 14. Moreover, w(x,y) represents a pixel value of the particular region image. By performing such a conversion, visibility of a scene is improved and the particular region is performed a brightness enhancement which is different from what is performed on the other region. Further, in the present exemplary embodiment, an enhancement curve is exemplified as the shape of the function f, however, any shapes may be adapted. For example, a plane curve among an area, a curve like S-shape which enhances contrast or the like may be adapted.

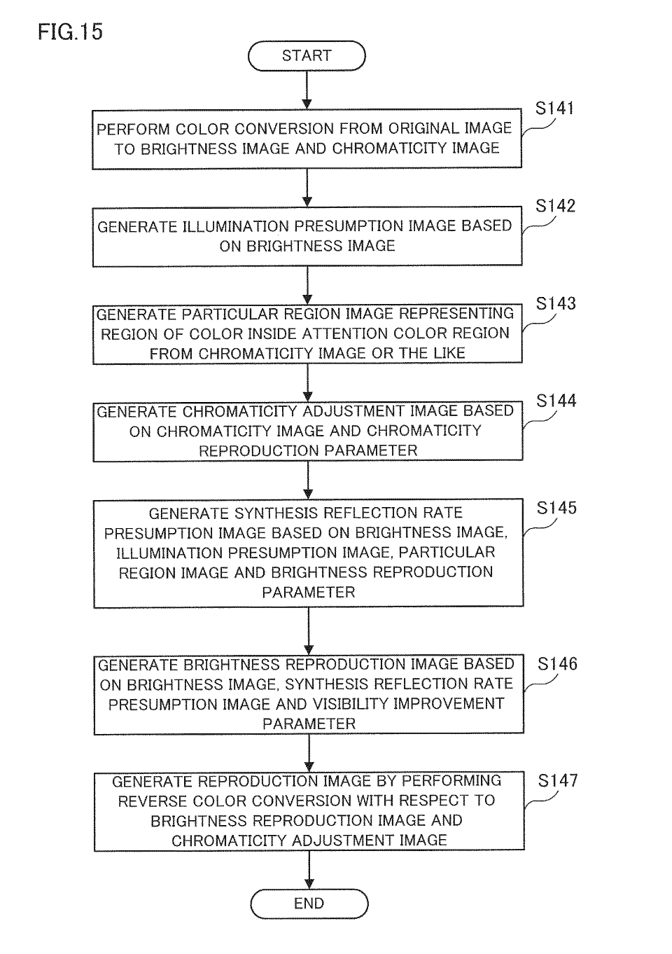

FIG. 15 is a flowchart showing an operation example of the image processor in the third exemplary embodiment of the present invention.

When the original image is inputted, firstly, the color converting portion 11 generates the brightness image and the chromaticity image by performing, on the original image, the color conversion from the color space of the original image to color space of brightness and chromaticity (step 141).

Next, the illumination presuming portion 12 generates the illumination presumption image based on the brightness image generated in step 141 as shown in FIG. 3 and FIG. 4 (step 142). Moreover, the particular region generating portion 14 generates the particular region image which represents the particular region having the color inside the attention color region from the chromaticity image or the like generated in step 141 (step 143). Further, the chromaticity reproducing portion 18 generates the chromaticity adjustment image based on the chromaticity image generated in step 141 and the chromaticity reproduction parameter (step 144). Herein, step 142 to step 144 are performed in this order, however, those steps may be performed in any orders. Otherwise, at least two steps of step 142 to step 144 may be performed in parallel.

Subsequently, the synthesis reflection rate presuming portion 16 generates the synthesis reflection rate presumption image based on the brightness image generated in step 141, the illumination presumption image generated in step 142, the particular region image generated in step 143, and the brightness reproduction parameter (step 145).

After that, the brightness reproducing portion 17 generates the brightness reproduction image based on the brightness image generated in step 141, the synthesis reflection rate presumption image generated in step 145, and the visibility improvement parameter (step 146).

Lastly, the color reverse converting portion 19 generates the reproduction image by performing a color conversion reverse to the color conversion performed by the color converting portion 11, that is, by performing a color conversion from the color space of brightness and chromaticity to the color space of the original image, with respect to the brightness reproduction image generated in step 146 and the chromaticity adjustment image generated in step 144 (step 147).

[Hardware Configuration of Image Processor]

The image processor 10 in the present exemplary embodiment is realized, for example, as an image processing software that is installed in a personal computer, however, typically realized as the image processor 10 that performs an image reading and an image formation.

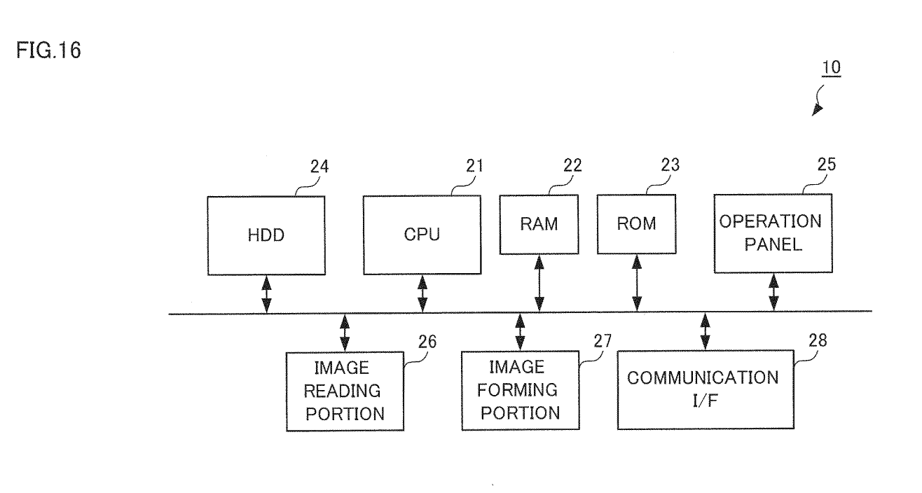

FIG. 16 is a block diagram showing a hardware configuration example of the image processor 10. As shown in the figure, the image processor 10 includes a Central Processing Unit (CPU) 21, a Random Access Memory (RAM) 22, a Read Only Memory (ROM) 23, a Hard Disk Drive (HDD) 24, an operation panel 25, an image reading portion 26, and image forming portion 27 and a communication interface (hereinbelow, referred to as “communication I/F”) 28.

The CPU 21 loads various programs stored in the ROM 23 or the like into the RAM 22, and then executes the programs, thereby to implement functions to be described later.

The RAM 22 is a memory that is used as a working memory or the like for the CPU 21.

The ROM 23 is a memory that stores, therein, the various programs executed by the CPU 21.

The HDD 24 is, for example, a magnetic disk device that stores, therein, image data having been read by the image reading portion 26, image data used for image formation in the image forming portion 27, and the like.

The operation panel 25 is, for example, a touch panel that displays various kinds of information and receives an operation input by a user. Here, the operation panel 25 is configured with a display that displays various kinds of information and a position detecting sheet that detects a position designated by a finger, a stylus pen or the like.

The image reading portion 26 reads an image recorded on a recording medium such as paper. The image reading portion 26 herein is, for example, a scanner. The scanner to be used may employ one of the following two systems: a CCD system in which reflected light of light emitted from a light source and directed at an original is reduced by a lens and is then received by charge coupled devices (CCD); and a CIS system in which reflected light of light beams sequentially emitted from LED light sources and directed at an original is received by a contact image sensor (CIS).

The image forming portion 27 forms an image on a recording medium. The image forming portion 27 herein is, for example, a printer. The printer to be used may employ one of the following two systems: an electrophotographic system in which an image is formed by transferring toner attached to a photoconductive drum onto a recording medium; and an ink jet system in which an image is formed by ejecting ink onto a recording medium.

The communication I/F 28 transmits and receives various kinds of information to and from other devices through a network.

The program that achieves the present exemplary embodiment may be provided not only by a communication unit but also by being stored in a recording medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment as chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processor comprising:
a color converting unit that converts an original image to a brightness image in which a brightness component of the original image is set to be a pixel value and a chromaticity image in which a chromaticity component of the original image is set to be a pixel value;
an illumination image generating unit that generates, from the brightness image, an illumination image in which an illumination component of the original image is set to be a pixel value;
an image generation processing unit that executes a processing for generating a brightness reproduction image which is reproduced so that visibility of the original image is enhanced, based on the brightness image, the illumination image, and an enhancing degree information which represents an enhancing degree of a reflection rate component of the original image,
a chromaticity adjustment image generating unit that generates a chromaticity adjustment image by adjusting chromaticity of the chromaticity image, and
a color reverse converting unit that performs a conversion reverse to a color conversion performed by the color converting unit, with respect to the brightness reproduction image and the chromaticity adjustment image.

2. The image processor according to claim 1 further comprising a region image generating unit that generates, from at least any one of the brightness image and the chromatic image, a region image which represents a region of color inside a designated color region in the original image, wherein
the image generation processing unit executes a processing for generating the brightness reproduction image further based on the region image and a brightness enhancing degree information which represents an enhancing degree of brightness of the region.

3. The image processor according to claim 1, wherein the image generation processing unit further includes:
a reflection rate image generating unit that generates a reflection rate image in which a reflection rate component of the original image is set to be a pixel value based on the brightness image and the illumination image, and
a brightness reproduction image generating unit that generates the brightness reproduction image based on the brightness image, the reflection rate image, the reflection rate enhancing degree information, the region image, and the brightness enhancing degree information.

4. The image processor according to claim 3, wherein the brightness reproduction image generating unit generates the brightness reproduction image based on the brightness enhancing degree information which controls a shape of a function enhancing brightness of the region by converting the brightness component of the region.

5. The image processor according to claim 2, wherein the image generation processing unit further includes:
a reflection rate image generating unit that generates a reflection rate image in which a reflection rate component of the original image is set to be a pixel value, based on the brightness image, the illumination image, the region image, and the brightness enhancing degree information, and
a brightness reproduction image generating unit that generates the brightness reproduction image based on at least the reflection rate image and the reflection rate enhancing degree information.

6. The image processor according to claim 5, wherein the reflection rate image generating unit generates the reflection rate image based on the brightness enhancing degree information which controls a shape of a function which enhances brightness of the region by converting brightness components of the region.

7. A non-transitory computer readable medium storing a program causing a computer to execute a process for controlling an image processor, the process comprising:
performing color conversion to convert an original image to a brightness image in which a brightness component of the original image is set to be a pixel value and a chromaticity image in which a chromaticity component of the original image is set to be a pixel value,
generating, from the brightness image, an illumination image in which an illumination component of the original image is set to be a pixel value,
executing a processing for generating a brightness reproduction image which is reproduced so that visibility of the original image is enhanced, based on the brightness image, the illumination image, and an enhancing degree information which represents an enhancing degree of a reflection rate component of the original image,
generating a chromaticity adjustment image by adjusting chromaticity of the chromaticity image, and
performing a conversion reverse to the color conversion with respect to the brightness reproduction image and the chromaticity adjustment image.
